(19) United States
(12) Patent Application Publication
(10) Pub. No.: US 2013/0173804 A1
(43) Pub. Date: Jul. 4, 2013

(54) System and Method for Providing Effective Resource Reusability Management in a Virtualized Environment

(71) Applicants: Sindhu K. Murthy, Bangalore (IN); Shuvan Saha, Bangalore (IN)

(72) Inventors: Sindhu K. Murthy, Bangalore (IN); Shuvan Saha, Bangalore (IN)

(73) Assignee: DELL PRODUCTS, LP, Round Rock, TX (US)

(21) Appl. No.: 13/340,815

(22) Filed: Dec. 30, 2011

(51) Int. Cl. G06F 15/173

(52) U.S. Cl. 709/226

(57) ABSTRACT

A virtual system management server includes an infrastructure manager, a workload manager, and a system director. The infrastructure manager manages a computing resource of a virtualized environment and determines a utilization of the computing resource. The workload manager allocates the computing resource to a workload and launches the workload on the virtualized environment. The system director receives the utilization from the infrastructure manager, determines that the utilization is less than a utilization threshold, and directs the workload manager to reclaim a portion of the computing resource from the workload in response to determining that the utilization is less than the utilization threshold.

### FIELD OF THE DISCLOSURE

The present disclosure generally relates to information handling systems, and more particularly relates to providing effective resource reusability management in a virtualized environment.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, and networking systems. Information handling systems can also implement various virtualized architectures.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of a virtualized environment according to an embodiment of the present disclosure;

FIG. 2 is a table illustrating a workload policy in the virtualized environment of FIG. 1 according to an embodiment of the present disclosure;

FIGS. 3 and 4 illustrate a table of workload utilization information in the virtualized environment of FIG. 1 according to an embodiment of the present disclosure;

FIG. 5 is a table illustrating another workload policy in the virtualized environment of FIG. 1 according to an embodiment of the present disclosure;

FIGS. 6 and 7 show a flowchart illustrating a method of providing effective resource reusability management in a virtualized environment according to an embodiment of the present disclosure; and

FIG. 8 is a block diagram illustrating an information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

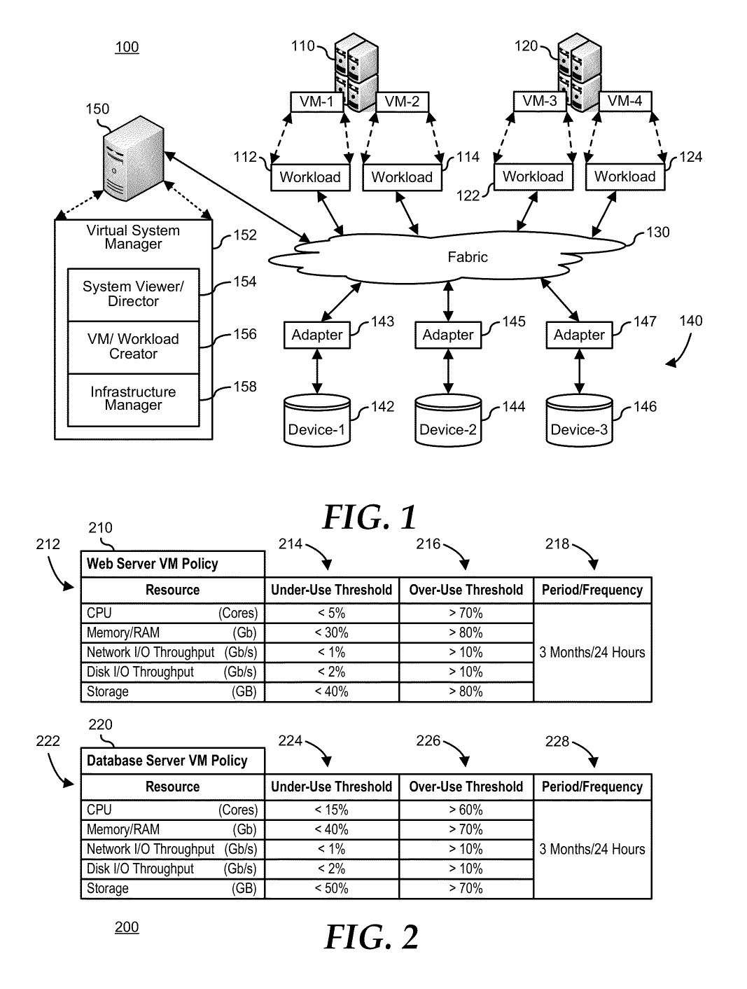

FIG. 1 illustrates virtualized environment 100 that can include one or more information handling systems. For purposes of this disclosure, the information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a PDA, a consumer electronic device, a network server or storage device, a switch router or other network communication device, or any other suitable device and may vary in size, shape, performance, functionality, and price. The information handling system may include memory, one or more processing resources such as a central processing unit (CPU) or hardware or software control logic, and operates to execute code. Additional components of the information handling system may include one or more storage devices that can store code, one or more communications ports for communicating with external devices as well as various input and output (110) devices, such as a keyboard, a mouse, and a video display. The information handling system may also include one or more buses operable to transmit communications between the various hardware components.

In a particular embodiment, virtualized environment 100 includes a host processing system 110, one or more additional host processing systems 120, a switched fabric 130, a storage area network (SAN) 140, and a management server 150. The processing resources of host processing systems 110 and 120 are allocated to one or more virtual machines operating on their respective host processing system to perform associated workloads. As such, host processing system 110 includes a workload 112 associated with a first virtual machine (VM-1) and one or more additional workloads 114 associated with one or more additional virtual machines (VM-2). Similarly, host processing system 120 includes a workload 122 associated with a third virtual machine (VM-3) and one or more additional workloads 124 associated with one or more additional virtual machines (VM-4). Workloads 112, 114, 122, and 124 share the resources of host bus adapters (not illustrated) within their respective host processing systems 110 and 120 to gain access to the network switching functionality of fabric 130 and to the data storage functionality of SAN 140. The host bus adapters transfer data between their respective host processing systems 110 and 120 and fabric 130 according to a particular protocol associated with the fabric. A non-limiting example of a fabric 130 includes a Small Computer System Interface (SCSI) fabric, a Fibre Channel (FC) fabric, an Internet SCSI (iSCSI) fabric, another data fabric or any combination thereof.

SAN 140 includes one or more storage devices represented by storage devices 142, 144, and 146. Each storage device 142, 144, and 146 operates to store and retrieve data for workloads 112, 114, 122, and 124, and includes an associated device adapter 143, 145, and 147, respectively. Device adapters 143, 145, and 147 operate to receive data in a format suitable for communication via fabric 130, and to provide the received data in a suitable format for the respective storage device 142, 144, and 146. Storage devices 142, 144, and 146 can represent physical storage devices such as disk storage arrays, tape backup storage devices, solid state storage devices, other physical storage devices, or a combination thereof. Also, storage devices 142, 144, and 146 can represent virtual storage devices such as virtual partitions on one or more physical storage device. Moreover, storage devices 142, 144, and 146 can represent a combination of physical and virtual storage devices. As such, device adapters 143, 145, and 147 can represent physical device adapters, virtual device adapters, or a combination thereof.

Management server 150 is connected to fabric 130, and includes a virtual system manager 152. Virtual system manager 152 includes a system viewer/director 154, a VM/workload creator 156, and an infrastructure manager 158. In operation, virtual system manager 152 provides an integrated end-to-end solution whereby host processing systems 110 and 120, fabric 130, and SAN 140 are configured to rapidly deploy virtual machines, to allocate storage devices 142, 144, and 146 and device adapters 143, 145, and 147 to the virtual machines, and to launch workloads 112, 114, 122, and 124 on the virtual machines.

Infrastructure manager 158 integrates the separate elements of virtualized environment 100 into a single pool of resources that are available for virtualization and deployment. As such, host processing systems 110 and 120 are managed as a common computing resource, such that their respective number of processing units (CPUs) and associated memory are dynamically allocatable to instantiate virtual machines and to execute workloads on the virtual machines. Similarly, the network interfacing capabilities of host processing systems 110 and 120, fabric 130, and device adapters 143, 145, and 147 are managed as a common network I/O resource, and storage devices 142, 144, and 146 are managed as a common storage resource. In a particular embodiment, infrastructure manager 158 tracks resource utilization within virtualized environment 100. As such, infrastructure manager 158 can determine if host processing systems 110 and 120 are being efficiently utilized by tracking CPU and memory utilization, the network I/O throughput of host bus adaptors on the host processing systems, or other resources of the host processing systems, as needed or desired. Similarly, infrastructure manager 158 can determine if fabric 130, storage devices 142, 144, and 146, and device adaptors 143, 145, and 147 are being efficiently utilized by tracking traffic switching volume of the switching resources of the fabric, usage and availability of the storage devices, storage I/O throughput in the device adaptors, and other utilization as needed or desired.

VM/workload creator 156 provides for the active management of the resources that are pooled by infrastructure manager 158 and deployment of workloads 112, 114, 122, and 124. Based upon the services and applications that are requested by the user base of virtualized environment 100, VM/workload creator 156 maps workloads 112, 114, 122, and 124 to the requests and launches new workloads within the pooled resources to efficiently meet the requests. As such, VM/workload creator 156 operates to determine the resources needed to implement a particular workload 112, 114, 122, or 124. For example, VM/workload creator 156 can determine a number of CPUs or processing cores within the CPUs, a quantity of system memory of the associated host processing systems 110 or 120, a network I/O capacity, a storage I/O capacity, a quantity of storage, or other resources needed to efficiently implement the workloads 112, 114, 122, and 124.

In a particular embodiment, VM/workload creator 156 tracks the resource utilization of workloads 112, 114, 122, and 124. As such, VM/workload creator 156 can determine if host processing systems 110 and 120 are being efficiently utilized by tracking CPU and memory utilization, the network I/O throughput of host bus adaptors on the host processing systems, or other resources of the host processing systems, as needed or desired. Similarly, infrastructure manager 158 can determine if fabric 130, storage devices 142, 144, and 146, and device adaptors 143, 145, and 147 are being efficiently utilized by tracking traffic switching volume of the switching resources of the fabric, usage and availability of the storage devices, storage I/O throughput in the device adaptors, and other utilization as needed or desired. Moreover, VM/workload creator 156 and infrastructure manager 158 provide for the identification of underutilized and overutilized resources and for the reclamation or reallocation of the resources to ameliorate the underuse or overuse.

For example, VM/workload creator 156 can determine that each of workloads 112, 114, 122, and 124 are allocated a number of CPUs, a quantity of memory, and a quantity of network bandwidth or a network throughput of the associated host processing systems 110 and 120, and can determine the utilization, for example by calculating a percentage of the allocated resources that is actually being utilized by the workloads. Similarly, infrastructure manager 158 can determine that each of workloads 112, 114, 122, and 124 are allocated a quantity of network bandwidth or a network throughput of fabric 130 and of device adaptors 143, 145, and 147, and a quantity of storage on storage devices 142, 144, and 146, and can determine the utilization, for example by calculating a percentage of the allocated resources that is actually being utilized by the workloads. VM/workload creator 156 and infrastructure manager 158 provide the resource utilization information to system viewer/director 154. Note that the determination of the utilization of resources that is performed by VM/workload creator 156, and by infrastructure manager 158 can be based upon other measures than a calculated percentage, such as amount of memory or storage that is used by a particular workload 112, 114, 122, or 124, or other measure, as needed or desired.

System viewer/director 154 provides an operations hub for virtual environment 100, giving support personnel a comprehensive view of the virtual environment. As such, system viewer/director 154 includes what-if and trend analysis functions, capacity and utilization reporting functions, and cost allocation and chargeback functions, giving the support personnel visibility into virtualized environment 100 and better information upon which to take action, and to efficiently manage the virtualized environment and to plan for future growth and development more effectively. System viewer/director 154 also directs VM/workload creator 156 to launch workloads 112, 114, 122, and 124, and directs infrastructure manager 158 to allocate the resources of virtualized environment 100 to implement the workloads.

System viewer/director 154 also receives the resource utilization information that is determined by VM/workload creator 156 and infrastructure manager 158, and compares the information with threshold levels for underuse and overuse for each resource to determine if each resource is being underutilized or overutilized. System viewer/director 154 provides workload policies that include underutilization and overutilization thresholds for the resources of virtualized environment 100, and compares the actual utilization levels of the resources with the thresholds to determine if a particular resource is underutilized or overutilized. If a particular resource is underutilized, system viewer/director 154 directs VM/workload creator 156 and infrastructure manager 158 to reclaim a portion of the particular resource, and place the reclaimed resource into a pool of available resources of virtualized environment 100. If the particular resource is overutilized, system viewer/director 154 directs VM/workload creator 156 and infrastructure manager 158 to allocate more of the particular type of resource.

FIG. 2 illustrates an embodiment of workload policies 200 including a web server VM policy 210, and a database server VM policy 220. Web server VM policy 210 includes a resource list 212, an underuse threshold list 214, an overuse threshold list 216, and a modification period and monitoring frequency field 218. Similarly, database server VM policy 220 includes a resource list 222, an underuse threshold list 224, an overuse threshold list 226, and a modification period and monitoring frequency field 228. Web server VM policy 210, and a database server VM policy 220 are exemplary of the types of policies that can be included in workload policy 200, and other policies can be added to accommodate other types of workloads, as needed or desired. Resource lists 212 and 222 include entries for various types of resources that can be separately allocated within virtualized environment 100. A non-limiting example of the types of resources that can be allocated includes CPUs or processor threads, host system memory, and host network adapter I/O throughput in host processing systems 110 and 120, fabric I/O throughput in fabric 130, storage adapter I/O throughput in device adapters 143, 145, and 147, storage device allocation in storage devices 142, 144, and 146, another type of resource, or a combination thereof, as needed or desired.

Underuse threshold lists 214 and 224 include entries that are associated with each entry of the respective resource lists 212 and 222, and that provide an underuse threshold limit for each type of resource. When the resource utilization information for a particular resource, as provided by VM/workload creator 156 or infrastructure manager 158, is below the associated underuse threshold entry, then that resource is deemed to be underused. Similarly, overuse threshold lists 216 and 226 include entries that are associated with each entry of the respective resource lists 212 and 222, and that provide an overuse threshold limit for each type of resource, such that when the resource utilization information for a particular resource is above the associated overuse threshold entry, then that resource is deemed to be overused. The threshold entries in threshold lists 214, 216, 224, and 226 are settable by support personnel for virtualized environment 100, and in a particular embodiment workload policies 200 represent a user interface that operates on system viewer/director 154, and provides support personnel with access to the threshold lists.

Modification period and monitoring frequency fields 218 and 228 provide a time period at which underused resources are reclaimed and at which additional resources are allocated for overused resources. In the illustrated example, reclamation and reallocation of resources can be performed every 3 months. Other modification periods can be applied, such as daily, weekly, monthly, or another period, as needed or desired. Modification period and monitoring frequency fields 218 and 228 also provide a monitoring frequency at which the resources are measured for underuse or overuse. In the illustrated example, underuse and overuse is monitored as a twenty-four hour running average. Other monitoring frequencies can be applied, such as hourly, weekly, monthly, or another monitoring frequency, as needed or desired. In a particular embodiment, modification period and monitoring frequency fields 218 and 228 can be based upon a peak use level such that any underuse or overuse of a resource can trigger reclamation and reallocation of the resources. The modification periods and monitoring frequencies in modification period and monitoring frequency fields 218 and 228 are settable by support personnel for virtualized environment 100.

In the illustrated embodiment, modification period and monitoring frequency fields 218 and 228 are applied globally to their respective VM policies 210 and 220, such that the reclamation and reallocation of resources is performed for all of the resources of a particular VM policy according to the same modification period, and the monitoring frequencies are the same for all types of resources. In another embodiment, not illustrated, each entry in resource lists 212 and 222 is provided with an associated modification period and monitoring frequency field, such that the reclamation and allocation of each particular resource is performed according to a modification period and monitoring frequency that is associated with that type of resource. For example, a particular resource such as network storage space may be tightly constrained, such that a more frequent reclamation and allocation is desired, and the monitoring is based upon a shorter duration. In yet another embodiment, a combination of global modification periods and monitoring frequencies can be applied to a group of resource types, and one or more other resource types can have their own modification period and monitoring frequency. In a further embodiment, a particular resource can have a first modification period and monitoring frequency in VM policy 210, and a different modification period and monitoring frequency in VM policy 220.

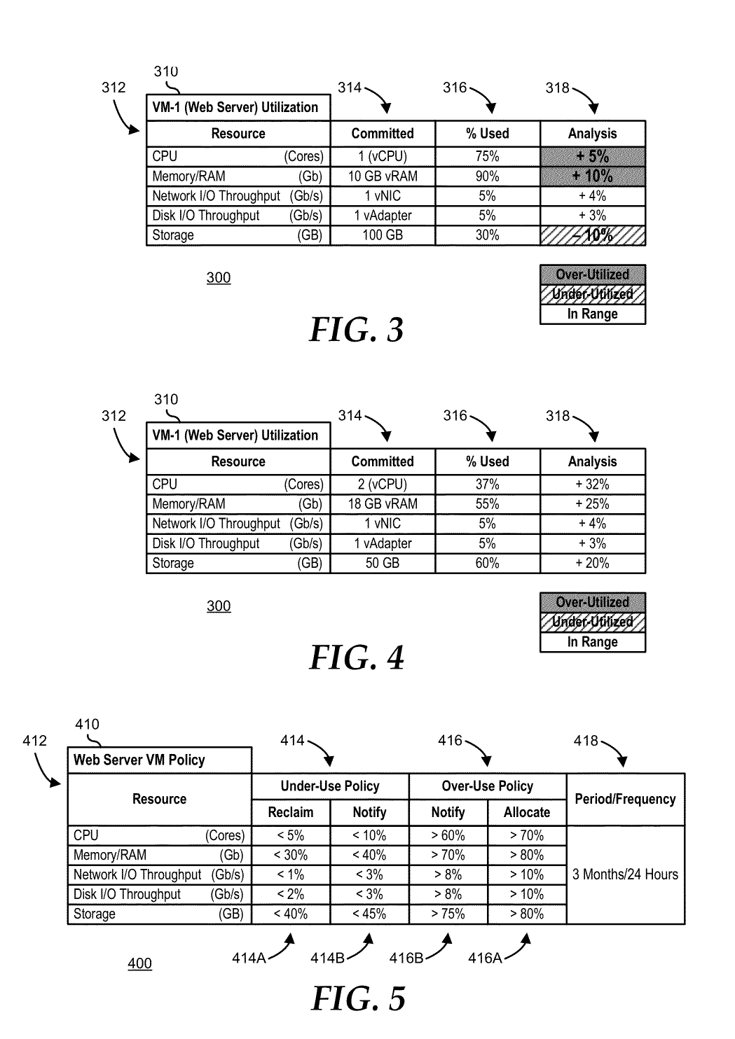

FIGS. 3 and 4 illustrate an embodiment of workload utilization information 300 including a web server VM utilization 310, as provided to system viewer/director 154 from VM/workload creator 156 and infrastructure manager 158. Web server VM utilization 310 shows exemplary utilization information for VM-1 operating on host processing system 110 and includes a resource list 312, a committed resource list 314, a current utilization list 316, and an analysis result list 318. Web server VM utilization 310 is exemplary, and other types of workload utilization information for other workloads can be considered, as needed or desired. Resource list 312 includes entries for each type of resources that are allocated to VM-1. Committed resource list 314 includes entries that are associated with each entry of resource list 312, and that show the current allocation of the quantity of the associated resource that is committed to the operation of the workload. Current utilization list 316 includes entries that are associated with each entry of resource list 312, and that show the current utilization level of each committed resource, as determined by VM/workload creator 156 and infrastructure manager 158. Analysis result list 318 includes entries that are associated with each entry of resource list 312.

FIG. 3 illustrates web server VM utilization 310 at a time just before the end of the modification period of modification period and monitoring frequency field 218. The entries in analysis result list 318 each show one of three cases. Where the value in the associated current utilization list 316 is less than the associated underuse threshold value in underuse threshold list 214, the associated entry in analysis result list 318 flags the resource as being underutilized (as, for example, with the cross-hatched field), and the value of the entry is the difference between the current usage value and the underuse threshold value. For example, VM-1 is allocated 100 gigabytes (GB) of storage, but the 100 GB is only 30% utilized. The associated underuse threshold value is 40%, so VM-1 is underutilizing its allocated storage resources by 10%. Where the value is greater than the associated overuse threshold value in overuse threshold list 216, the associated entry flags the resource as being overutilized (as, for example, with the darkened field), and the value of the entry is the difference between the current usage value and the overuse threshold value. For example, VM-1 is allocated 10 GB of virtual RAM, and the 10 GB is 90% utilized. The associated overuse threshold value is 80%, so VM-1 is overutilizing its allocated RAM by 10%. CPU utilization is similarly seen to be overutilized by 5%. Where the value is between the associated underuse threshold value and the associated overuse threshold value, the associated entry is shown as being in range, and the value is the difference between the current usage value and the underuse threshold value. For example, the network I/0 throughput and disk I/O throughput for VM-1 are in range.

At the end of the modification period of modification period and monitoring frequency field 218, system viewer/director 154 directs VM/workload creator 156 to allocate more CPU resources and vRAM resources to VM-1 to ameliorate the overutilization of those resources, and directs infrastructure manager 158 to reclaim a portion of storage allocated to VM-1 into the pool of available storage. FIG. 4 illustrates web server VM utilization 310 at a time just after the modification period of modification period and monitoring frequency field 218. Here, VM-1 has been allocated an additional virtual CPU and an additional 8 GB of vRAM, and has ceded back 50 GB of allocated storage, and all of the current usage values in current usage list 316 are in range, as indicated by analysis results list 318.

FIG. 5 illustrates an embodiment of a workload policy 400 including a web server VM policy 410, similar to web server VM policy 210. Web server VM policy 410 includes a resource list 412, an underuse threshold list 414, an overuse threshold list 416, and a modification period and monitoring frequency field 418. Resource list 412 is similar to resource list 212, and modification period and monitoring frequency field 418 is similar to modification period and monitoring frequency field 218

Underuse threshold list 414 includes a reclaim threshold list 414A and an underuse notify threshold list 414B. Reclaim threshold list 414A is similar to underuse threshold list 214. Underuse notify threshold list 414B includes entries that are associated with each entry of the resource list 412, and that provide an underuse warning threshold limit for each type of resource. When the resource utilization information for a particular resource, as provided by VM/workload creator 156 or infrastructure manager 158, is below the associated underuse notify threshold entry, but above the associated underuse threshold entry, then that resource is deemed to be close to being underused, and a notification is provided to the support personnel for virtualized environment 100 that the particular resource is within the warning threshold. Overuse threshold list 416 includes an allocate threshold list 416A and an overuse notify threshold list 416B. Allocate threshold list 416A is similar to overuse threshold list 216. Overuse notify threshold list 416B includes entries that are associated with each entry of the resource list 412, and that provide an overuse warning threshold limit for each type of resource. When the resource utilization information for a particular resource is above the associated overuse notify threshold entry, but below the associated overuse threshold entry, then that resource is deemed to be close to being overused, and a notification is provided to the support personnel.

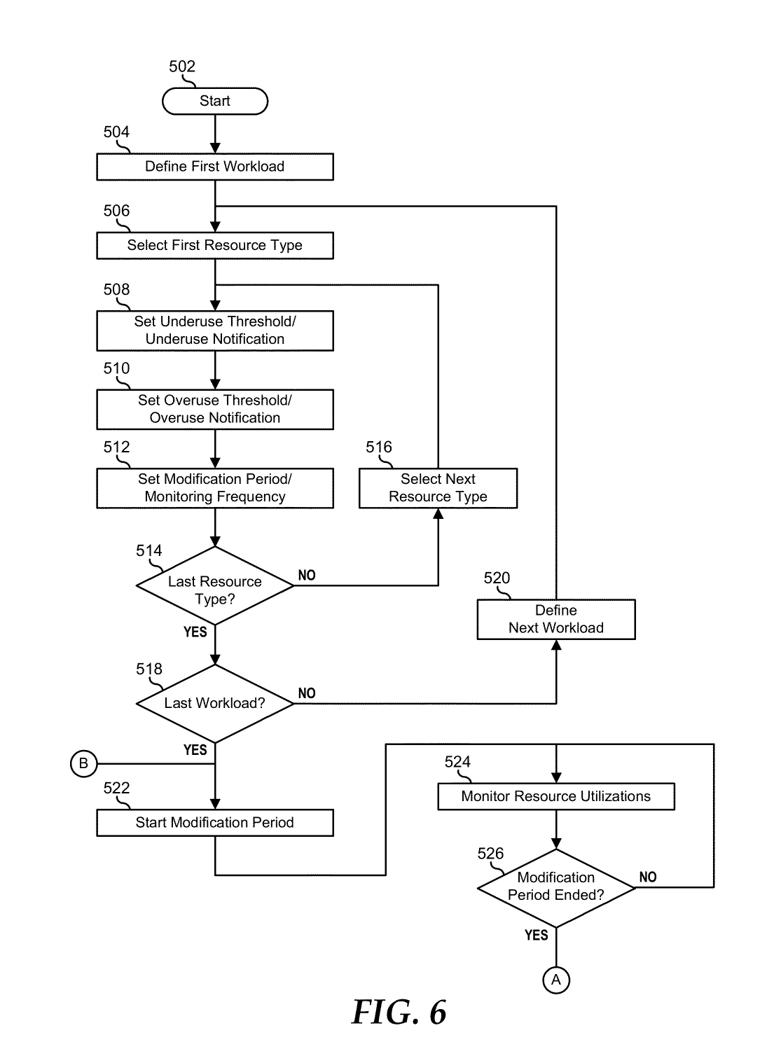

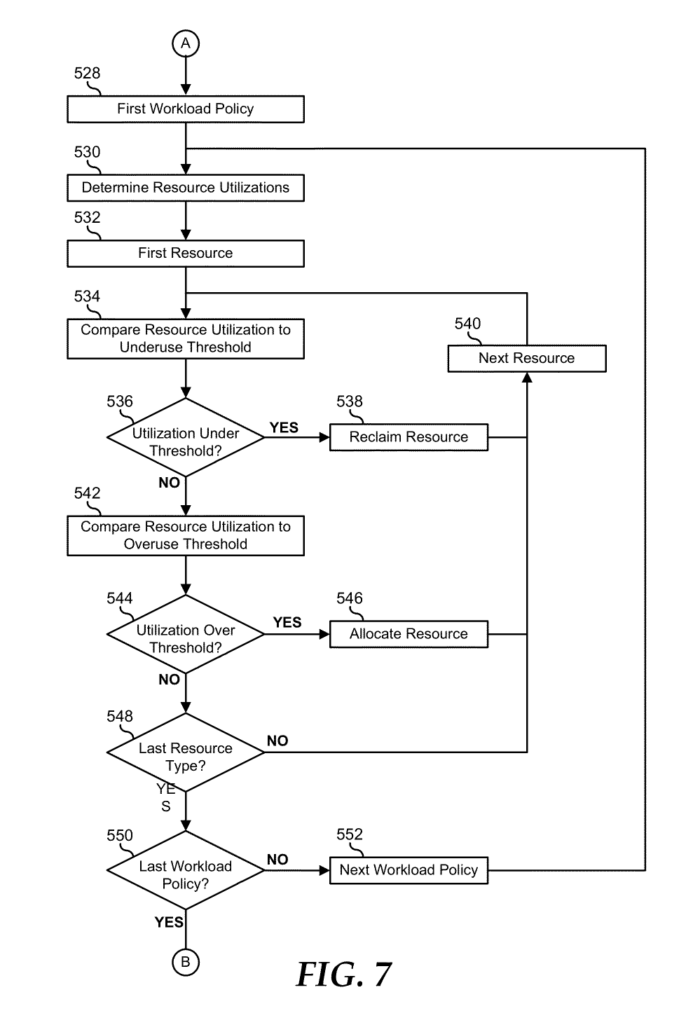

FIGS. 6 and 7 illustrate a method of providing effective resource reusability management in a virtualized environment similar to virtualized environment 100, starting at block 502. A first workload is defined in block 504. For example, a user of virtualized environment 100 can submit a demand for resources to perform a processing task to virtual system manager 152 that can be managed by system viewer/director 154, VM/workload creator 156, and infrastructure manager 158 to allocate resources of the virtualized environment, to launch a virtual machine on one of host processing systems 110 or 120, and to initiate one of workloads 112, 114, 122, or 124 on the associated virtual machine.

After the first workload is defined, a workload policy is created for the first workload in blocks 506 through 516, as follows. A first resource type is selected in block 506. For example, the allocated CPUs can be selected first for creating underuse and overuse thresholds. Another resource can be selected as needed or desired. An underuse threshold and optionally an underuse notification threshold are set for the selected resource in block 508. For example, support personnel for virtualized environment 100 can access a user interface similar to VM policies 210, 220, or 410 to set the underuse threshold and the underuse notification threshold for the selected resource. An overuse threshold and optionally an overuse notification threshold are set for the selected resource in block 510. For example, the support personnel can access the user interface to set the overuse threshold and the overuse notification threshold. A modification period and monitoring frequency is set, either globally for the policy, or for the selected resource, in block 512. For example, the support personnel can access the user interface to set the modification period and monitoring frequency field that is to be applied globally to the policy, or for the selected resource. A decision is made as to whether or not the selected resource is the last resource to be considered in the policy in decision block 514. If not, the “NO” branch of decision block 514 is taken, a next resource type is selected in block 516, and the method returns to block 508 where an underuse threshold and optionally an underuse notification threshold are set for the newly selected resource. If the selected resource is the last resource to be considered in the policy, then the policy is fully created, the “YES” branch of decision block 514 is taken to decision block 518.

A decision is made as to whether or not the workload is the last workload to be defined in decision block 518. If not, the “NO” branch of decision block 518 is taken, a next workload is defined in block 520, and the method returns to block 506 where a first resource type for the newly defined workload is selected. If the workload is the last workload to be defined, the “YES” branch of decision block 518 is taken, and the modification period is started in block 522. The monitoring of the resource utilizations for the resources of the workloads is begun in block 524. For example, VM/workload creator 156 and infrastructure manager 158 can track the utilization of the resources of virtualized environment 100. The tracking can be based upon the monitoring frequency that is set for each resource. A decision is made as to whether or not a modification period for a particular resource has ended in decision block 526. If not, the “NO” branch of decision block 526 is taken, and the method returns to block 524 where the monitoring of the resource utilizations for the resources of the workloads is continued until a modification period for has ended. The particular modification period can include a globally applied modification period, or can include a modification period for one or more particular resources. If the modification period for the particular resource has ended, the “YES” branch of decision block 526 is taken and the reclamation and allocation of the resources of the virtualized environment is performed in blocks 528 through 552, as follows. Note that the method as illustrated in blocks 528 through 552 assumes that the modification period is globally applied to the resources of all workloads. However, the skilled artisan will recognize that the method is adaptable to apply to the reclamation and allocation of resources within a single workload when the modification period is applied to all of the resources of the single workload, or to the reclamation and allocation of one or more resource within a workload when the modification period is applied to a subset of the resources of a workload.

A first workload policy is selected for modification in block 528. For example, one of VM policies 210, 220, or 410 can be selected for evaluation and modification. The resource utilizations for the resources of the selected workload are determined in block 530. For example, VM/workload creator 156 and an infrastructure manager 158 can determine the current utilizations of the resources in current utilization list 316 for web server VM utilization 310, and workload utilization information 300 can be provided to system view/director 154. A first resource within the policy is selected in block 532. The resource utilization for the selected resource is compared to the underuse threshold for the selected resource in block 534. For example, the current utilization entry for the selected resource can be compared to the associated underuse threshold value. A decision is made as to whether or not the resource utilization is lower than the underuse threshold for the selected resource in decision block 536. If so, the “YES” branch of decision block 536 is taken, a portion of the selected resource is reclaimed in block 538, a next resource within the policy is selected in block 540, and the method returns to block 534 where the resource utilization for the newly selected resource is compared to the underuse threshold for the newly selected resource. For example, a particular resource can be determined to be underutilized, and a portion of the resource can be reclaimed from the selected workload to be placed into the pool of resources of virtualized environment 100, and an next resource can be selected for evaluation.

If the resource utilization determined in block 530 is not lower than the underuse threshold for the selected resource, the “NO” branch of decision block 536 is taken, and the resource utilization for the selected resource is compared to the overuse threshold for the selected resource in block 542. For example, the current utilization entry for the selected resource can be compared to the associated overuse threshold value. A decision is made as to whether or not the resource utilization is greater than the overuse threshold for the selected resource in decision block 544. If so, the “YES” branch of decision block 544 is taken, additional resources of the particular type are allocated to the workload in block 546, and a next resource within the policy is selected in block 540. For example, a particular resource can be determined to be overutilized, and additional resources can be allocated to the selected workload form the pool of resources of virtualized environment 100.

If the resource utilization is not greater than the overuse threshold for the selected resource, the “NO” branch of decision block 544 is taken, and a decision is made as to whether or not the selected resource is the last resource in the selected workload policy in block 548. If not, the “NO” branch of decision block 548 is taken and a next resource within the policy is selected in block 540. If the selected resource is the last resource in the selected workload policy, the “YES” branch of decision block 548 is taken, and a decision is made as to whether or not the selected workload policy is the last workload policy in decision block 550. If not, the “NO” branch of decision block 550 is taken, a next workload policy is selected in block 552, and the method returns to block 530 where the resource utilizations for the resources of the newly selected workload are determined. If the selected workload policy is the last workload policy, the “YES” branch of decision block 550 is taken and the method returns to block 522 where a next modification period is started.

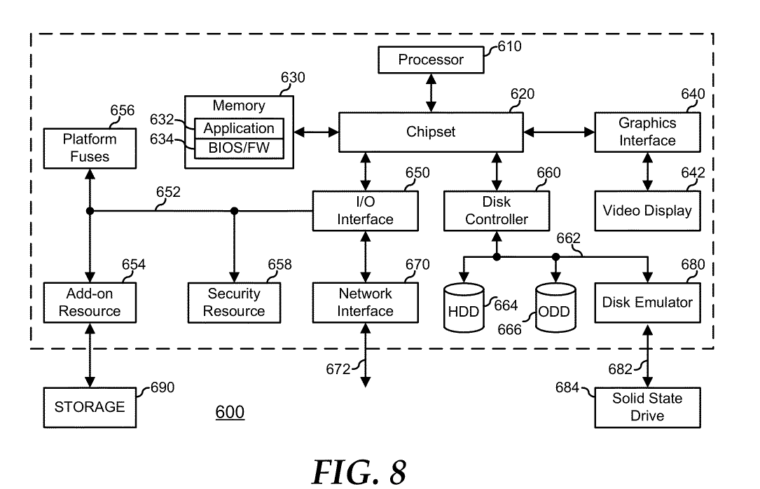

FIG. 8 is a block diagram illustrating an embodiment of an information handling system 600, including a processor 610, a chipset 620, a memory 630, a graphics interface 640, an input/output (I/O) interface 650, a disk controller 660, a network interface 670, and a disk emulator 680. In a particular embodiment, information handling system 600 is used to carry out one or more of the methods described herein. In another embodiment, one or more of the systems described herein are implemented in the form of information handling system 600.

Chipset 620 is connected to and supports processor 610, allowing the processor to execute machine-executable code. In a particular embodiment (not illustrated), information handling system 600 includes one or more additional processors, and chipset 620 supports the multiple processors, allowing for simultaneous processing by each of the processors and permitting the exchange of information among the processors and the other elements of the information handling system. Chipset 620 can be connected to processor 610 via a unique channel, or via a bus that shares information among the processor, the chipset, and other elements of information handling system 600.

Memory 630 is connected to chipset 620. Memory 630 and chipset 620 can be connected via a unique channel, or via a bus that shares information among the chipset, the memory, and other elements of information handling system 600. In another embodiment (not illustrated), processor 610 is connected to memory 630 via a unique channel. In another embodiment (not illustrated), information handling system 600 includes separate memory dedicated to each of the one or more additional processors. A non-limiting example of memory 630 includes static random access memory (SRAM), dynamic random access memory (DRAM), non-volatile random access memory (NVRAM), read only memory (ROM), flash memory, another type of memory, or any combination thereof.

Graphics interface 640 is connected to chipset 620. Graphics interface 640 and chipset 620 can be connected via a unique channel, or via a bus that shares information among the chipset, the graphics interface, and other elements of information handling system 600. Graphics interface 640 is connected to a video display 642. Other graphics interfaces (not illustrated) can also be used in addition to graphics interface 640 as needed or desired. Video display 642 includes one or more types of video displays, such as a flat panel display, another type of display device, or any combination thereof.

I/O interface 650 is connected to chipset 620. I/O interface 650 and chipset 620 can be connected via a unique channel, or via a bus that shares information among the chipset, the I/O interface, and other elements of information handling system 600. Other I/O interfaces (not illustrated) can also be used in addition to I/O interface 650 as needed or desired. I/O interface 650 is connected via an I/O interface 652 to one or more add-on resources 654. Add-on resource 654 is connected to a storage system 690, and can also include another data storage system, a graphics interface, a network interface card (NIC), a sound/video processing card, another suitable add-on resource or any combination thereof. I/O interface 650 is also connected via I/O interface 652 to one or more platform fuses 656 and to a security resource 658. Platform fuses 656 function to set or modify the functionality of information handling system 600 in hardware. Security resource 658 provides a secure cryptographic functionality and includes secure storage of cryptographic keys. A non-limiting example of security resource 658 includes a Unified Security Hub (USH), a Trusted Platform Module (TPM), a General Purpose Encryption (GPE) engine, another security resource, or a combination thereof.

Disk controller 660 is connected to chipset 620. Disk controller 660 and chipset 620 can be connected via a unique channel, or via a bus that shares information among the chipset, the disk controller, and other elements of information handling system 600. Other disk controllers (not illustrated) can also be used in addition to disk controller 660 as needed or desired. Disk controller 660 includes a disk interface 662. Disk controller 660 is connected to one or more disk drives via disk interface 662. Such disk drives include a hard disk drive (HDD) 664, and an optical disk drive (ODD) 666, and can include one or more disk drive as needed or desired. ODD 666 can include a Read/Write Compact Disk (R/W-CD), a Read/Write Digital Video Disk (R/W-DVD), a Read/Write mini Digital Video Disk (R/W mini-DVD, another type of optical disk drive, or any combination thereof. Additionally, disk controller 660 is connected to disk emulator 680. Disk emulator 680 permits a solid-state drive 684 to be coupled to information handling system 600 via an external interface 682. External interface 682 can include industry standard busses such as USB or IEEE 1394 (Firewire) or proprietary busses, or any combination thereof. Alternatively, solid-state drive 684 can be disposed within information handling system 600.

Network interface device 670 is connected to I/O interface 650. Network interface 670 and I/O interface 650 can be coupled via a unique channel, or via a bus that shares information among the I/O interface, the network interface, and other elements of information handling system 600. Other network interfaces (not illustrated) can also be used in addition to network interface 670 as needed or desired. Network interface 670 can be a network interface card (NIC) disposed within information handling system 600, on a main circuit board such as a baseboard, a motherboard, or any combination thereof, integrated onto another component such as chipset 620, in another suitable location, or any combination thereof. Network interface 670 includes a network channel 672 that provide interfaces between information handling system 600 and other devices (not illustrated) that are external to information handling system 600. Network interface 670 can also include additional network channels (not illustrated).

Information handling system 600 includes one or more application programs 632, and Basic Input/Output System and Firmware (BIOS/FW) code 634. BIOS/FW code 634 functions to initialize information handling system 600 on power up, to launch an operating system, and to manage input and output interactions between the operating system and the other elements of information handling system 600. In a particular embodiment, application programs 632 and BIOS/FW code 634 reside in memory 630, and include machine-executable code that is executed by processor 610 to perform various functions of information handling system 600. In another embodiment (not illustrated), application programs and BIOS/FW code reside in another storage medium of information handling system 600. For example, application programs and BIOS/FW code can reside in HDD 664, in a ROM (not illustrated) associated with information handling system 600, in an option-ROM (not illustrated) associated with various devices of information handling system 600, in storage system 690, in a storage system (not illustrated) associated with network channel 672, in another storage medium of information handling system 600, or a combination thereof. Application programs 632 and BIOS/FW code 634 can each be implemented as single programs, or as separate programs carrying out the various features as described herein.

In the embodiments described herein, an information handling system includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system can be a personal computer, a consumer electronic device, a network server or storage device, a switch router, wireless router, or other network communication device, a network connected device (cellular telephone, tablet device, etc.), or any other suitable device, and can vary in size, shape, performance, price, and functionality. The information handling system can include memory (volatile (e.g. random-access memory, etc.), nonvolatile (read-only memory, flash memory etc.) or any combination thereof), one or more processing resources, such as a central processing unit (CPU), a graphics processing unit (GPU), hardware or software control logic, or any combination thereof. Additional components of the information handling system can include one or more storage devices, one or more communications ports for communicating with external devices, as well as, various input and output (I/O) devices, such as a keyboard, a mouse, a video/graphic display, or any combination thereof. The information handling system can also include one or more buses operable to transmit communications between the various hardware components. Portions of an information handling system may themselves be considered information handling systems.

When referred to as a “device,” a “module,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The device or module can include software, including firmware embedded at a device, such as a Pentium class or PowerPC™ brand processor, or other such device, or software capable of operating a relevant environment of the information handling system. The device or module can also include a combination of the foregoing examples of hardware or software. Note that an information handling system can include an integrated circuit or a board-level product having portions thereof that can also be any combination of hardware and software.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A virtual system management server, comprising:
a memory device including processor-executable code; and
a processor operable to execute code to implement:
an infrastructure manager that:
manages a first computing resource of a virtualized environment; and
determines a first utilization of the first computing resource;
a workload manager that:
allocates the first computing resource to a workload; and
launches the workload on the virtualized environment; and
a system director that:
receives the first utilization from the infrastructure manager;
determines that the first utilization is less than a first utilization threshold; and
directs the workload manager to reclaim a portion of the first computing resource from the workload in response to determining that the first utilization is less than the first utilization threshold.

2. The virtual system management server of claim 1, wherein:
the infrastructure manager further:
manages a second computing resource of the virtualized environment; and
determines a second utilization of the second computing resource;
the workload manager further allocates the second computing resource to the workload; and
the system director further:
receives the second utilization from the infrastructure manager;
determines that the second utilization is greater than the second utilization threshold and is less than a third utilization threshold; and
provides a warning that the second computing resource is underutilized in response to determining that the second utilization is greater than the second utilization threshold and is less than the third utilization threshold.

3. The virtual system management server of claim 1, wherein:
the infrastructure manager further:
manages a second computing resource of the virtualized environment; and
determines a second utilization of the second computing resource;
the workload manager further allocates the second computing resource to the workload; and
the system director further:
receives the second utilization from the infrastructure manager;
determines that the second utilization is greater than a second utilization threshold; and
directs the workload manager to allocate a third computing resource to the workload in response to determining that the second utilization is greater than the second utilization threshold.

4. The virtual system management server of claim 3, wherein:
the infrastructure manager further:
manages a third computing resource of the virtualized environment; and
determines a third utilization of the third computing resource;
the workload manager further allocates the third computing resource to the workload; and
the system director further:
receives the third utilization from the infrastructure manager;
determines that the third utilization is less than the second utilization threshold and is greater than a third utilization threshold; and
provides a warning that the third computing resource is overutilized in response to determining that the second utilization is less than the second utilization threshold and is greater than the third utilization threshold.

5. The virtual system management server of claim 1, wherein determining that the first utilization is less than a first utilization threshold is in response to a modification period.

6. The virtual system management server of claim 1, wherein the first utilization of the first computing resource is determined by the infrastructure manager in response to a measurement frequency.

7. The virtual system management server of claim 6, wherein the measurement frequency provides a running average of a measure of the utilization of the first computing resource.

8. The virtual system management server of claim 1, wherein the first utilization threshold is settable by an operator of the virtual system management server.

9. A method of managing a virtualized environment, the method comprising:
allocating by a workload management server a first hardware computing resource of the virtualized environment to a workload;
launching by the workload management server the workload on the virtualized environment;
determining by an infrastructure manager a first utilization of the first hardware computing resource;
receiving at a system director the first utilization from the infrastructure manager;
determining that the first utilization is less than a first utilization threshold; and
directing the workload management server to reclaim a portion of the first hardware computing resource from the workload in response to determining that the first utilization is less than the first utilization threshold.

10. The method of claim 9, further comprising:
allocating by the workload management server a second hardware computing resource of the virtualized environment to the workload;
determining by the infrastructure manager a second utilization of the second hardware computing resource;
receiving at the system director the second utilization from the infrastructure manager;
determining that the second utilization is greater than the second utilization threshold and is less than a third utilization threshold; and
providing a warning that the second hardware computing resource is underutilized in response to determining that the second utilization is greater than the second utilization threshold and is less than the third utilization threshold.

11. The method of claim 9, further comprising:
allocating by the workload management server a second hardware computing resource of the virtualized environment to the workload;
determining by the infrastructure manager a second utilization of the second hardware computing resource;
receiving at the system director the second utilization from the infrastructure manager;
determining that the second utilization is greater than a second utilization threshold; and
directing the workload management server to allocate a third hardware computing resource to the workload in response to determining that the second utilization is greater than the second utilization threshold.

12. The method of claim 11, further comprising:
allocating by the workload management server a third hardware computing resource of the virtualized environment to the workload;
determining by the infrastructure manager a third utilization of the third hardware computing resource;
receiving at the system director the third utilization from the infrastructure manager;
determining that the third utilization is less than the second utilization threshold and is greater than a third utilization threshold; and
providing a warning that the third hardware computing resource is overutilized in response to determining that the second utilization is less than the second utilization threshold and is greater than the third utilization threshold.

13. The method of claim 9, wherein determining that the first utilization is less than a first utilization threshold is in response to a modification period.

14. The method of claim 9, wherein the first utilization of the first hardware computing resource is determined by the infrastructure manager in response to a measurement frequency.

15. A non-transitory storage medium having code for carrying out a method, the method comprising:
allocating by a workload manager a first computing resource of a virtualized environment to a workload;
launching by the workload manager the workload on the virtualized environment;
determining by an infrastructure manager a first utilization of the first computing resource;
receiving at a system director the first utilization from the infrastructure manager;
determining that the first utilization is less than a first utilization threshold; and
directing the workload manager to reclaim a portion of the first computing resource from the workload in response to determining that the first utilization is less than the first utilization threshold.

16. The storage medium code of claim 15, the method further comprising:
allocating by the workload manager a second computing resource of the virtualized environment to the workload;
determining by the infrastructure manager a second utilization of the second computing resource;
receiving at the system director the second utilization from the infrastructure manager;
determining that the second utilization is greater than the second utilization threshold and is less than a third utilization threshold; and
providing a warning that the second computing resource is underutilized in response to determining that the second utilization is greater than the second utilization threshold and is less than the third utilization threshold.

17. The storage medium code of claim 15, the method further comprising:
allocating by the workload manager a second computing resource of the virtualized environment to the workload;
determining by the infrastructure manager a second utilization of the second computing resource;
receiving at the system director the second utilization from the infrastructure manager;
determining that the second utilization is greater than a second utilization threshold; and
directing the workload manager to allocate a third computing resource to the workload in response to determining that the second utilization is greater than the second utilization threshold.

18. The storage medium code of claim 17, the method further comprising:
allocating by the workload manager a third computing resource of the virtualized environment to the workload;
determining by the infrastructure manager a third utilization of the third computing resource;
receiving at the system director the third utilization from the infrastructure manager;
determining that the third utilization is less than the second utilization threshold and is greater than a third utilization threshold; and
providing a warning that the third computing resource is overutilized in response to determining that the second utilization is less than the second utilization threshold and is greater than the third utilization threshold.

19. The storage medium code of claim 15, wherein determining that the first utilization is less than a first utilization threshold is in response to a modification period.

20. The storage medium code of claim 15, wherein the first utilization of the first computing resource is determined by the infrastructure manager in response to a measurement frequency.
